(19) United States
(12) Patent Application Publication
(10) Pub. No.: US 2007/0253626 A1
(43) Pub. Date: Nov. 1, 2007

(54) Resizing Raw Image Data Before Storing The Data

(76) Inventors: Eric Jeffrey, Richmond (CA); Barinder Singh Rai, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/380,552

(22) Filed: Apr. 27, 2006

(51) Int. Cl. G06K 9/36; G06K 9/32; H04N 5/228

(52) U.S. Cl. 382/232; 382/299; 348/222.1

(57) ABSTRACT

The invention is directed, in one embodiment, to a method of: (a) receiving raw image data representing an image, (b) transforming the raw image data to change at least one dimension of the image, and (c) storing the raw image data in a memory subsequent to the step (b) of transforming the image data. The step (b) preferably transforms the raw image data by cropping or scaling the image.

### FIELD OF INVENTION

The present invention is directed to a method and apparatus for resizing raw image data before storing the data.

### BACKGROUND

Mobile telephones, personal digital assistants, portable music players, digital cameras, and other similar devices enjoy widespread popularity today. These small, light-weight devices typically rely on a battery as the primary power source during use. Because of their popularity, competition among makers of these devices is intense. Accordingly, there is an ever-present need to minimize the cost, size, weight, and power consumption of the components used in these devices.

There is also a need to add features to these devices in order to make particular devices more appealing than other devices to consumers. A common feature now found in many of these battery-powered mobile devices is an image sensor integrated circuit (“IC”) for capturing digital photographs. Adding an image capture feature, however, increases both the amount of memory needed and the demands on available memory bandwidth, which in turn increase component size and power consumption. Moreover, the image sensor is often employed to capture video rather than still images, which multiplies memory and memory bandwidth proportionally.

Of course, the need to minimize cost, size, weight, and power consumption of components is not limited to battery-powered mobile devices. It is generally important to minimize these design parameters in all computer and communication systems.

Thus, there is a need to reduce memory requirements, demands on available memory bandwidth, and power consumption associated with an image capture feature in computer and communication systems, and particularly, in battery-powered mobile devices. Accordingly, there is a need for a method and apparatus for resizing raw image data before storing the data.

### SUMMARY

In one embodiment, the invention is directed to a method of: (a) receiving raw data representing an image, (b) transforming the raw image data to change at least one dimension of the image, and (c) storing the raw image data in a memory subsequent to the step (b) of transforming the image data. In various embodiments, the step of (b) transforming the raw image data crops or scales the image.

In another embodiment, the invention is directed to a device that includes an image sensor for generating raw data representing an image and a resizing unit coupled with the image sensor. The resizing unit is preferably adapted for dimensionally transforming the raw image data and for writing the raw image data to a memory. The device preferably also includes a memory for storing the raw image data. In various embodiments, the resizing unit is adapted to transform the raw image data by cropping or scaling the image.

In yet another embodiment, the invention is directed to a graphics processing unit. The graphics processing unit includes a memory for storing raw image data and a resizing unit for dimensionally transforming the raw image data. The graphics processing unit preferably includes a memory for storing the raw image data. In various embodiments, the resizing unit is adapted to transform the raw image data by scaling or cropping the image.

In a further embodiment, the invention is directed to a program of instruction embodied on a computer readable medium for performing a method of: (a) receiving raw data representing an image; (b) transforming the raw image data to change the dimensions of the image; and (c) causing the transformed raw image data to be stored in a memory. The dimensional transformation may be scaling, cropping, or both.

### DETAILED DESCRIPTION OF THE DRAWINGS

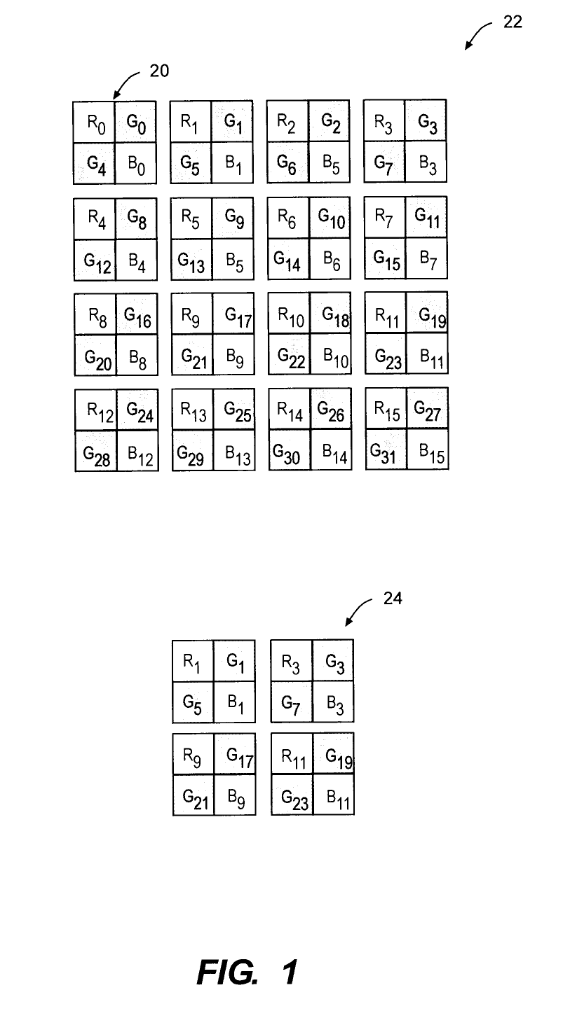

FIG. 1 illustrates an exemplary raw image and a scaled raw image.

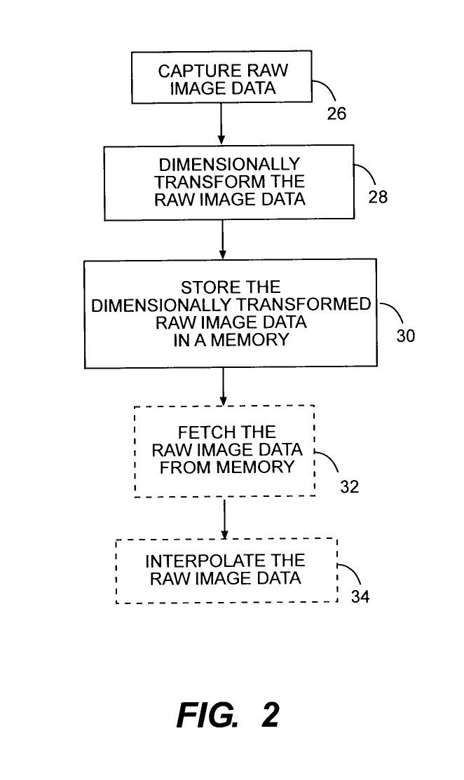

FIG. 2 shows a flow diagram of a preferred method for defining parameters according to the present invention.

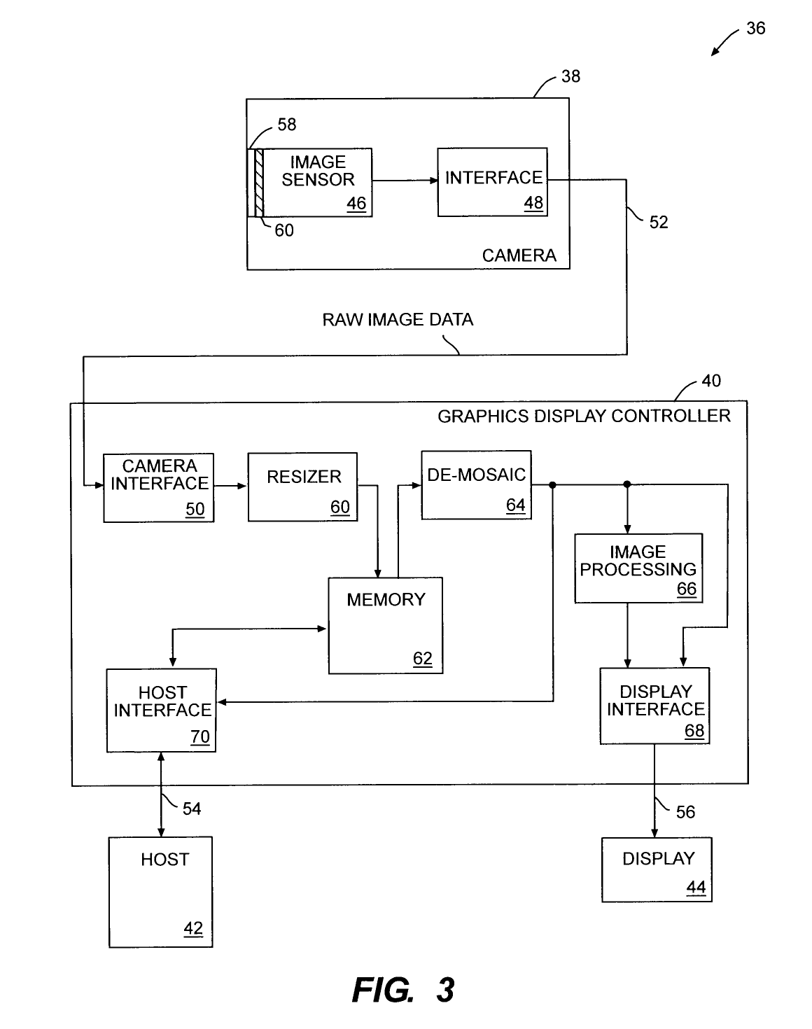

FIG. 3 is a block diagram of a preferred device including a memory according to the present invention.

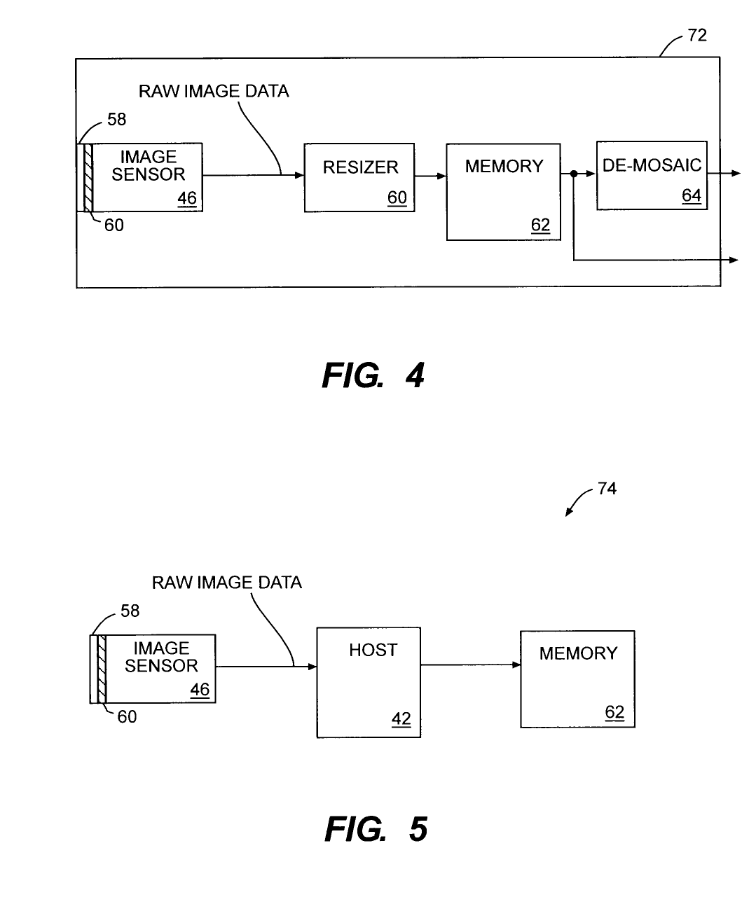

FIG. 4 is a block diagram illustrating of a first alternative embodiment according to the present invention.

FIG. 5 is a block diagram illustrating of a second alternative embodiment according to the present invention.

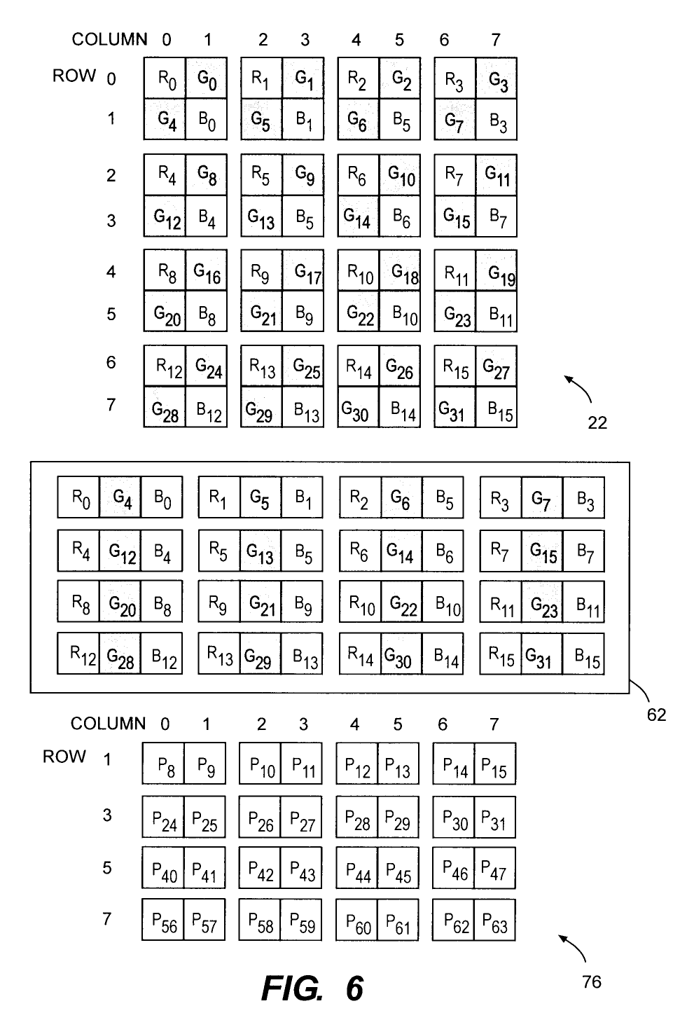

FIG. 6 shows the exemplary raw image of FIG. 1, the memory of FIG. 3, and a scaled, de-mosaiced image for illustrating how a scaling algorithm may be adapted to preserve color information.

### DETAILED DESCRIPTION

Preferred embodiments of the invention are directed to a methods, apparatus, and articles of manufacture for resizing raw image data before storing the data.

“Raw image data” generally refers to the data created by an image sensor or other photosensitive device (“image sensor”). Image sensors usually have an array of a large number of small, light-detecting elements (“photosites”), each of which is able to convert photons into electrons. When an image is projected onto the array, the incident light is converted into an analog voltage at each photosite that is subsequently converted to discrete, quantized voltage, thereby forming a two-dimensional array of thousands or millions digital values for defining a corresponding number of pixels that may be used to render an image. Exemplary image sensors include charge coupled devices (“CCDs”) and complimentary metal oxide semi-conductor (“CMOS”) image sensors. Image sensors are commonly disposed on a discrete, dedicated integrated circuit (“IC”).

Generally, the photosites provided in an image sensor are not capable of distinguishing color however; they produce “gray-scale” pixels. Color digital images are captured by pairing an image sensor with a color filter array (“CFA”). Alternatively, color images can be captured with a device that uses several image sensors. In these devices, each of the image sensors is adapted to be responsive only to light a particular region of the spectrum, such as with the use of single-color filters, and appropriate optics are provided so that that an image is projected onto each of the sensors in the same manner. Devices that employ a single image sensor are simpler (and less expensive) than devices having multiple image sensors, and accordingly, such devices are ordinarily used in battery-powered mobile devices. While one or more preferred embodiments of the present invention employ a single image sensor paired with a CFA, it should be appreciated that raw image data may be provided by any source.

In single image sensor devices, the CFA is placed in the optical path between the incident light and the array of photosites. The CFA includes one filter for each of the photosites and is positioned so that each filter is aligned to overlap with one of the photosites. Generally, three types of filters are provided, each type for passing only light of one region of the visible spectrum. In this way, each photosite is adapted to be responsive only to light in a particular region of the spectrum.

A commonly used CFA is a “Bayer” CFA. The individual filters in the Bayer CFA are adapted for passing light of either the red, green, or blue regions of the spectrum. FIG. 1 shows a Bayer pattern 20 that together form a raw image 22. The Bayer filter 20 covers a 2×2 block of photosites and includes one red, one blue, and two green filters. The two green filters correspond to two diagonally opposed photosites. The red and blue filters may correspond to either of the two remaining photosites, but the same correspondence is maintained for all of the blocks.

An image sensor overlaid with a CFA outputs one raw pixel per photosite. These raw pixels may be 8, 10, or another number of bits per pixel. Raw pixels are generally not suitable for viewing on an LCD, CRT, or other types of display devices. Typically, display devices require pixels that have a red, green, and blue component (“RGB” pixels). RGB pixels are commonly 8 bits per component, or 24 bits per pixel. While raw pixels are ordinarily 8 or 10 bits, and RGB pixels are ordinarily 24 bits, it will be appreciated that any number of bits may be employed for representing raw pixels or pixels comprised of components.

Raw pixels must first be converted to RGB pixels before an image can be displayed (or converted to another color space). From FIG. 1 it can be seen that the raw image 22 that results from using a Bayer mask 20 has the appearance of a mosaic. Raw image pixels are usually converted into RGB pixels using a de-mosaicing algorithm that interpolates neighboring raw pixels. There are a variety of known de-mosaicing algorithms that may be used, such as nearest neighbor replication; bilinear, bicubic, spline, Laplacian, hue, and log hue interpolation; and estimation methods that adapt to features of the area surrounding the pixel of interest. It will be appreciated that the term “pixel” is used herein to refer at times to the binary elements of raw image data generated by an image sensor overlaid with a CFA (“raw pixels”), at times to the binary elements of data suitable for various for image processing operations and manipulations, and rendering by a display device, such as RGB pixels (“pixels”), and at times to the display elements of a display device, the appropriate sense of the term being clear from the context.

Referring to FIG. 2, a flow diagram illustrating one embodiment of a method according to the invention is shown. In a first step 26, raw image data representing an image is captured. As described above, the raw image data includes an element of data for each of a plurality of light-sensitive photosites in an image sensor. Preferably, the raw image data is captured with a single image sensor overlaid with a CFA. Alternatively, the raw image data may be captured with a multiple-device or in another manner. Each photosite of the image sensor (or sensors) is responsive only to light of one of first, second, or third region of a spectrum. For example, the first region may be a red region, the second region may be a green region, and a third region may be a blue region. In a step 28, the raw image data is transformed to change the dimensions of the image. The step 28 preferable includes scaling the image. The transformation may either down-scale or up-scale the image. Further, any know scaling algorithm may be employed. In one embodiment, the image is up-scaled by duplicating pixels and down-scaled by deleting selected pixels. In alternative embodiments, other scaling algorithms may be employed, such as, for example, bi-linear, bi-cubic, or sync interpolation. In addition, other known scaling algorithms may be employed. Moreover, as described below, any known scaling algorithm may be adapted to preserve color information. In addition, the step 28 alternatively includes cropping the image. Moreover, the step 28 may include both scaling and cropping the image. While the image is preferably scaled in both the horizontal and vertical dimensions, this is not required. In alternative embodiments, the image is scaled in only one dimension, e.g., horizontal. In a step 30, the raw image data is stored in a memory. The step 30 follows the step 28 so that in the step 30, dimensionally transformed raw image data is stored.

The flow diagram of FIG. 2 also illustrates optional steps of fetching the raw image data from the memory in which is it stored (step 32), and interpolating the raw image data for creating processed image data (step 34). Any suitable de-mosaicing algorithm may be employed in step 34. The steps 32 and 34 are optionally performed subsequent to the step 30 of storing the raw image data.

After the dimensionally transformed image, comprised of raw pixels, is fetched from memory and de-mosaiced, the pixels may be stored, or further processed in a variety of ways. For instance, the image data may be converted to another color model, such as YUV. After the image data is converted to YUV, it may be chroma subsampled to create, for example, YUV 4:2:0 image data. In addition, the image data may be compressed using JPEG or another image compression technique. Further, the image data may be used to drive a display device for rendering the image or it may be transmitted to another system. In addition, the image data fetched from memory and subsequently de-mosaiced may be up-scaled, down-scaled, or cropped to fit a particular display device size. However, this latter step may not be necessary as the raw image was dimensionally transformed before storing.

There are several advantages of dimensionally transforming the raw image before storing it. As the amount of data is reduced before storing, the dimensionally transformed raw image takes less space in memory than the full raw image. This reduces memory requirements and the number of memory accesses needed to store and fetch the raw image. In addition, after the raw image is fetched from memory, the processing necessary to de-mosaic the dimensionally transformed raw image is less than that required for the full raw image.

Referring to FIG. 3, a block diagram of one exemplary embodiment of the invention is shown. The shown embodiment is a battery-powered, portable device 36 that preferably includes a camera module 38, a graphics display controller 40, a host 42, a display device 44, and a battery (not shown). The device 36 is preferably a computer or communication system, such as a mobile telephone, personal digital assistant, portable music player, digital camera, or other similar device. The graphics display controller 40 is preferably a discrete IC, disposed remotely from the camera module 38, the host 42, and the display device 44. In alternative embodiments, the components of the display controller or the camera module 38 may be provided individually or as a group in one or more other ICs or devices. In addition, it is not critical that a particular embodiment be implemented with a discrete camera 38 and a discrete display controller 40.

The camera module 38 includes an image sensor 46 and an interface unit 48. The image sensor 46 is preferably a single sensor of the CMOS type, but may be a CCD or other type of sensor. Preferably, a CFA 58 overlays a plurality of photosites 60 of the image sensor 46. With the CFA 58, each photosite of the image sensor 46 is adapted to respond only to light of a particular region of a spectrum. Preferably, the photosites are responsive only to light of one of a first, second, or third region of a spectrum. As one example, the photosites are responsive only to light of one of the red, green, or blue regions of the visible spectrum. Alternatively, a plurality of image sensors may be provided along with suitable optical elements for providing that the same image impinges in the same position on each of the multiple sensors, where each of the multiple sensors is adapted to respond only to light of a particular region of a spectrum.

The graphics display controller 40 is provided with a camera interface 50. The camera interface 50 and the interface unit 48 of the image sensor 46 are coupled with one another via a bus 52. The interface 48 serves to enable to the camera 38 to communicate with other devices over the bus 52 using a protocol required by the bus 52. Similarly, the camera interface 50 is adapted to enable the display controller 40 to communicate over the bus 52 using the protocol required by the bus 52. Accordingly, the camera interface 50 is able to receive raw image data from the camera module 38, as shown in FIG. 3, and provide this data to a resizer unit 60 of the graphics display controller 40. While FIG. 3 shows raw image data being flowing in one direction on the bus 52, it should be appreciated that the bus 52 is preferably employed for transmitting both data and instructions in either direction. Further, the bus 52 may be a serial or parallel bus, and may be comprised of two or more busses. In alternative embodiments, the interface 48 and the camera interface 50 may be omitted. For example, the resizer unit 60 may receive raw pixel data directly from the image sensor 46 or from another source.

The resizer unit 60 is adapted for receiving raw pixel data and outputting dimensionally transformed raw image data. In one embodiment, the resizer unit 60 includes an input coupled with the camera interface 50 and an output coupled with a memory 62. Raw pixels may be provided in raster order to the resizer unit 60 and the unit is preferably adapted to recognize the type of raw pixel as it is received. “Raster order” refers to a pattern in which the array of raw pixels is scanned from side to side in lines from top to bottom.

Assume that the raw pixels corresponding to one of red, green, and blue spectral regions, and referred to below simply as red, green, and blue raw pixels, are received in raster order by the resizer unit 60. Referring to the exemplary raw image 22 of FIG. 1, the resizer unit 60 receives image data in raster order, that is, in the order: R₀, G₀, R₁, G₁, . . . G₄, B₀, G₅, B₁, . . . . As raw pixels are received, the resizer unit 60 is adapted to recognize that R₀ is a red raw pixel, that G₀ is a green raw pixel, and that B₀ is a blue raw pixel. All of the raw pixels of particular type, e.g., red, are referred to as a “pixel plane,” and, in one preferred embodiment, each plane is resized independently. The ability of the resizer unit 60 to recognize the type of raw pixel as it is received facilitates the resizing process. After the resizer unit 60 recognizes the pixel type, it applies an algorithm for dimensionally transforming the image. In this way, the resizer unit 60 resizes the raw image without the need to first store the raw image in a memory. The resizer unit 60 may employ any known algorithm for either cropping or scaling an image. In one embodiment, the image is down-scaled by deleting selected pixels. In alternative embodiments, other scaling algorithms may be employed, including, but not limited to, bi-linear, bi-cubic, or sync interpolation. Moreover, as described below, any known scaling algorithm may be adapted to preserve color information. Accordingly, the resizer unit 60 applies a suitable resizing or cropping algorithm. In addition, resizer unit 60 may perform operations for both scaling and cropping the image. Moreover, while the image is preferably scaled in both the horizontal and vertical dimensions, this is not required. In alternative embodiments, the image is scaled in only one dimension, e.g., vertical. In one alternative, the resizer unit 60 applies a resizing algorithm for enlarging an image, such as by duplicating received pixels.

As one example of the operation of the resizer unit 60, consider the case of down-scaling the raw image using a scaling algorithm that deletes selected pixels in a regular pattern. For this example, assume that the raw image 22 of FIG. 1 is input to the resizer unit 60. The scaling algorithm provides that for the plane of red raw pixels, all pixels in odd rows are deleted, and within the even rows, even pixels are deleted. The plane of red raw pixels of the raw image 22 consists of the pixels:
R₀, R₁, R₂, R₃, R₄, R₅, R₆, R₇, R₈, R₉, R₁₀, R₁₁, R₁₂, R₁₃, R₁₄, R₁₅.
After deleting the pixels in the odd rows, the pixels in the even rows remain:
R₀, R₁, R₂, R₃, R₈, R₉, R₁₀, R₁₁.
And after deleting the even pixels, the following pixels remain:
R₁, R₃, R₉, R₁₁.
In this example, the scaling algorithm provides for deleting blue raw pixels from the blue plane in a similar manner. Green raw pixels are deleted a little differently. Alternate groups of two rows of the image are deleted. Within the remaining alternate groups of two rows, even pixels are deleted from the remaining rows. The scaled raw image 24 shown in FIG. 1 illustrates the result of applying this exemplary down-scaling method to the raw image 22.

As mentioned above, known scaling algorithms may be adapted to preserve color information. In other words, raw image data may be transformed in such a way that the color information of raw data that is eliminated from the image in the transformation (such as because of its spatial position in the image) is preserved for later use. To illustrate, assume that the raw image 22 is to be down-scaled in the vertical dimension by deleting even rows, leaving only the odd rows of the image. However, down-scaling a raw image by deleting even rows results in a raw image that has only green and blue raw pixels, as all of the red raw pixels (present only in the even rows) are deleted. When the scaled, raw image is processed using a de-mosaicing algorithm for the purpose of creating pixels having a red, green, and blue components, the algorithm will have no red color information with which to work. As this may present a difficulty, according to preferred embodiments, a scaling algorithm is adapted to preserve color information. In particular, the scaling algorithm is modified to save color information for a raw pixel that is removed from the image until such time that the color information of that raw pixel can be used in a de-mosaicing process. Continuing the example, the scaling algorithm is adapted to delete only the green pixels in even rows of the image, but the red pixels in the odd rows are saved, along with the all of the pixels in the odd rows, for later use by a de-mosaicing algorithm. FIG. 6 shows the exemplary raw image 22, the memory 62, and a scaled, de-mosaiced image 76 that together illustrate how this works. As can be seen in FIG. 6, green pixels in even rows are not stored in the memory 76. For example, the raw pixel G₀ is not stored in the memory 76. However, the red pixels in the even rows are stored in the memory. For example, the raw pixel R₀ is stored in the memory. In the raw image 22, the raw pixels G₄ and B₀ correspond to the RGB pixels P₈ and P₉ in the scaled, de-mosaiced image 76. Thus, even though the pixel at the position of the raw pixel R₀ is removed from the scaled image, by storing the raw pixel R₀ in memory, the de-mosaicing algorithm has the color information of that pixel available for use when it creates the RGB pixels P₈ and P₉. That is, the de-mosaicing algorithm raw pixels the color information of R₀, G₄, and B₀ for creating pixels P₈ and P₉. Accordingly, the pixels P₈ and P₉ include all three RGB components. One skilled in the art will appreciate that other scaling algorithms may be modified in a similar manner. In alternative embodiments, other scaling algorithms are similarly adapted to store color information of raw data that is eliminated from the image in dimensional transformation.

The output of the resizer unit 60 is preferably coupled with the memory 62. The memory 62 is preferably included in the display controller, but in alternative embodiments may be provided in a separate IC or device. The memory 62 may be a memory dedicated for the purpose of storing dimensionally transformed raw image, or may be a memory used for storing other data as well. Preferably, the memory 62 is of the DRAM type, but the memory 62 may be an SRAM, Flash memory, hard disk, floppy disk, or any other type of memory.

A de-mosaic unit 64 is preferably also included in the display controller 40. The de-mosaic unit 64 is adapted to fetch dimensionally transformed raw image that has been stored in the memory 62 by the resizer unit 60, to perform a de-mosaicing algorithm on the fetched data, and to output pixels. The de-mosaic unit 64 is preferably capable of employing any suitable de-mosaicing algorithm. Preferably, the de-mosaic unit 64 outputs 24-bit RGB pixels. Alternatively, the de-mosaic unit 64 outputs 24-bit YUV pixels. The de-mosaic unit 64 may employ any suitable de-mosaicing algorithm. The de-mosaic unit 64 may provide pixels to one or more destination units or devices. For example, the de-mosaic unit 64 may provide pixels to an image processing block 66, to a display interface 68, or to a host interface 70.

The image processing block 66 is adapted to perform one or more operations on image data, such as converting pixels from one color space to another, such as from RGB to YUV, sub-sampling YUV data to create, for example, YUV 4:2:0 data, or compressing image data using JPEG or another image compression technique. The image processing block 66 may provide its output to the memory 62 for storing processed data, to the host interface 70 for presentation to the host 42, or, as shown in FIG. 3, to the display interface 68 for driving a display device.

The display interface 68 is adapted to receive pixels suitable for display and to present the pixels to the display device 44 in accord with the protocol and timing requirements required by the display device 44.

As shown in FIG. 3, the display controller 40 is coupled with the host 42 and the display device 44 via buses 54 and 56, respectively. The host 52 may be a CPU or a digital signal processor (“DSP”) or other similar device. The host 52 is adapted to control various components of the device 36 and is preferably adapted to communicate with or to cause the device 36 to communicate with other computer and communication systems. The display device 44 is preferably an LCD, but may be any suitable display devices, such as a CRT, plasma display, or OLED. The host interface 70 is adapted to communicate with the host 42 over the bus 54 in conformity with the protocol required by the bus 54. While the host interface 70 is preferably adapted to receive data and commands from the host 42, its ability to also present data to the host 42 is useful in the context of the present invention. Specifically, the host interface 70 is adapted to receive processed image data output by the de-mosaicing unit 64 and to pass that data onto the host 42.

In operation, an image is captured by the image sensor 46 and raw pixel data is transmitted to the resizer unit 60 via the interface 48, bus 52, and camera interface 50. The resizer 60 recognizes the type of raw pixel as each is received and applies a scaling algorithm appropriate for the identified type of pixel, such as down-scaling the image by deleting some raw pixels and causing others to be stored in the memory 62. After the entire raw image has been captured, resized, and stored, the memory 62 contains only the raw pixels of the dimensionally transformed image. The de-mosaic unit 64 fetches dimensionally transformed raw image from the memory 62, and converts the raw pixels into RGB pixels. The RGB image data is then provided to other units for further processing or display.

The exemplary device 36 provides advantages over known devices. Specifically, by dimensionally transforming the raw image before storing it, the amount of data needed to be stored in the memory 62 is reduced. This reduces memory requirements and the number of memory accesses needed to store and to fetch the raw image. In addition, after the raw image is fetched from memory, the processing performed by the de-mosaic unit 64 on the dimensionally transformed raw image data is less than what would be required if the full raw image were stored.

FIGS. 4 and 5 show alternative embodiments of the invention. The same reference numbers used in FIGS. 4 and 5 to refer to the same or like parts described with respect to FIG. 3. FIG. 4 shows a module 72 that includes the image sensor 46, the resizer 60, the memory 62, and the de-mosaicing unit 64. In operation, an image is captured by the image sensor 46 of the module 72 and raw pixel data is transmitted to the resizer unit 60. The resizer 60 recognizes the type of raw pixel as each is received and applies a scaling algorithm appropriate for the identified type of pixel, such as down-scaling the image. Only the pixels of dimensionally transformed image are stored in the memory 62. Raw pixels may be fetched from memory by the de-mosaicing unit 64 or provided to another device or unit not shown.

FIG. 5 shows a system 74 that includes the image sensor 46, the host 42, and the memory 62. An image is captured by the image sensor 46 and raw pixel data is transmitted to the host 42. In the system 74, the host 42 is adapted to perform the functions of the resizer unit 60 by running a program of instructions. The program is preferably embodied on a computer readable medium for performing a method of: (a) receiving raw data representing an image; (b) transforming the raw image data to change the dimensions of the image; and (c) causing the transformed raw image data to be stored in a memory. The dimensional transformation may be scaling, cropping, or both. The host 42 stores only the pixels of dimensionally transformed image in the memory 62.

The present invention has been described for use with image data received from a camera that is integrated in the system or device. It should be appreciated that the invention may be practiced with image data that is received from any image data source, whether integrated or remote. For example, the image data may be transmitted over a network by a camera remote from the system or device incorporating the present invention.

Any of the operations described herein that form part of the invention are useful machine operations. The invention also relates to a device or an apparatus for performing these operations. The device may be specially constructed for the required purposes, such as the described mobile device, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include flash memory, hard drives, network attached storage, ROM, RAM, CDs, magnetic tapes, and other optical and non-optical data storage devices. The computer readable medium can also be distributed over a network-coupled computer system so that the computer readable code is stored and executed in a distributed fashion.

The above described invention may be practiced with a wide variety of computer system configurations including hand-held devices, microprocessor systems, microprocessor-based or programmable consumer electronics, minicomputers, mainframe computers and the like. Although the foregoing invention has been described in some detail for purposes or purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the invention is defined and limited only by the claims which follow.

We claim:

1. A method comprising:
(a) receiving raw data representing an image, the raw image data including a raw pixel for each of a plurality of light-sensitive photosites, each photosite being responsive only to light of one of a first region, a second region, and a third region of a spectrum;
(b) transforming the raw image data to change at least one dimension of the image; and
(c) storing the raw image data in a memory subsequent to the step (b) of transforming the image data.

2. The method of claim 1, wherein the step of (b) transforming the raw image data crops the image.

3. The method of claim 1, wherein the step (b) of transforming the raw image data scales the image.

4. The method of claim 3, wherein the step (b) of transforming the raw image data preserves color information of raw data eliminated by scaling.

5. The method of claim 1, wherein the raw image data is Bayer image data.

6. The method of claim 1, further comprising interpolating the raw image data for creating pixels defined by a plurality of color components subsequent to the step (c) of storing the raw image data.

7. A device, comprising:
an image sensor for generating raw data representing an image, the image sensor having a plurality of light-sensitive photosites and an output, the raw image data the raw image data including a raw pixel corresponding to each of the photosites; and
a resizing unit having an input coupled with the output of the image sensor, the resizing unit for dimensionally transforming the raw image data and for writing the raw image data to a memory.

8. The device of claim 7, further comprising a memory for storing the raw image data.

9. The device of claim 8, wherein the resizing unit is a host processor adapted for running a program of instructions embodied on a computer readable medium.

10. The device of claim 8, wherein the resizing unit is provided in a graphics display controller, and further comprising a host processor and a display device.

11. The device of claim 7, wherein the resizing unit is adapted to transform the raw image data by cropping the image.

12. The device of claim 7, wherein the resizing unit is adapted to transform the raw image data by scaling the image in one dimension.

13. The method of claim 12, wherein the resizing unit is adapted to transform the raw image data by scaling the image in two dimensions.

14. The device of claim 7, further comprising a interpolating unit for interpolating the raw image data, the interpolating unit for generating image data having pixels defined by a plurality of color components.

15. A graphics processing unit, comprising:
a memory for storing raw data representing an image, the raw image data including raw pixels defined by a particular intensity in a distinct one of a plurality of spectral regions;
a resizing unit for dimensionally transforming the raw image data.

16. The graphics processing unit of claim 15, further comprising a memory for storing the raw image data.

17. The graphics processing unit of claim 16, wherein the resizing unit is adapted for running a program of instructions embodied on a computer readable medium.

18. The graphics processing unit of claim 17, wherein the resizing unit is adapted to transform the raw image data by scaling the image.

19. The graphics processing unit of claim 16, wherein the resizing unit is adapted to transform the raw image data by scaling the image.

20. The graphics processing unit of claim 19, wherein the resizing unit is adapted to transform the raw image data by cropping the image.
